(19) United States
(12) Patent Application Publication
(10) Pub. No.: US 2015/0280369 A1
(43) Pub. Date: Oct. 1, 2015

(54) USB DETECTION MODULE

(71) Applicant: iRice Energy Technology(Shenzhen) Co., Ltd., Shen Zhen (CN)

(72) Inventors: SHIH-HUI CHEN, Taoyuan (TW); CHIN- TIEN LIN, Taoyuan (TW); CHIA-SHENG LIAO, Taoyuan (TW); QUN LIU, Taoyuan (TW)

(73) Assignee: iRice Energy Technology(Shenzhen) Co., Ltd., Shen Zhen (CN)

(21) Appl. No.: 14/227,017

(22) Filed: Mar. 27, 2014

(51) Int. Cl. H01R 13/703; H01R 13/66

(52) U.S. Cl. CPC H01R 13/703; H01R 13/6683

(57) ABSTRACT

A USB detection module for connecting a USB female socket and switching a transmission mode of each transmission terminal of the USB female socket includes a power control unit, an output unit, a detecting unit, a computing unit and an output control unit. The power control unit receives electric power; the output unit is connected to the power control unit and each transmission terminal of the USB female socket; the detecting unit is connected to the power control unit and the output unit; the output unit detects transmission terminals to obtain a detect signal; the computing unit is connected to the power control unit and the detecting unit to receive the detect signal and obtain a control signal; and the output control unit receives the control signal and switches a transmission mode corresponsive to the control signal; the power control unit controls the output unit according to the transmission mode.

### FIELD OF THE INVENTION

The present invention relates to a USB detection module, in particular to a detection module pluggable into a double-sided USB female socket.

### BACKGROUND OF THE INVENTION

As science and technology advance, computer becomes popular and is used extensively in our daily life. To cope with the fast development of computers and peripheral electronic devices, various different types of connectors are available in the market to connect the computers to the peripheral electronic devices of the same transmission interface for data transmission.

In general, a connector includes a male socket and a corresponding female socket, and the male and female sockets of different interface cannot be connected with each other. In addition, users have to follow a specific connecting direction to plug the male socket into the female socket. If the connecting direction is wrong, then the male socket and the female socket cannot be connected with each other.

For example, a universal serial bus (USB) connector includes a USB male socket and a USB female socket, and both sockets have a tongue installed therein, so that if the connecting direction is wrong, the tongues of the male and female sockets will conflict with each other, and the male socket will be unable to be plugged into the female socket. On one hand, such design provides a foolproof conflict for some users. On the other hand, this design is not flexible and inconvenient. Since users randomly plug the male socket into the female socket, therefore the chance of failure is ½, and user may require connecting the sockets twice. Obviously, the application is inconvenient to users.

Therefore, there is a double-sided female socket available in the market, and the tongue of the female socket is disposed at the central position of the socket to separate the socket into an upper accommodating area and a lower accommodating area, and a connecting terminal is designed at the top and bottom of the socket respectively. Therefore, if the front side of the male socket is plugged into the female socket, the tongue of the male socket will be plugged into the upper accommodating area of the female socket and electrically coupled to the connecting terminal in the upper accommodating area. If the back side of the male socket is plugged into the female socket, the tongue of the male socket will be plugged into the lower accommodating area of the female socket and electrically coupled to the connecting terminal in the lower accommodating area. Regardless of plugging the front or back side of the male socket into the female socket, the male and female sockets can be connected successfully to achieve an electric connection.

Compared with the general female socket, the aforementioned female socket comes with two sets of connecting terminals, and thus incurring a higher production cost and a larger volume.

### SUMMARY OF THE INVENTION

In view of the aforementioned drawbacks of the conventional, it is a primary objective of the present invention to provide a detection module pluggable into a double-sided USB female socket.

To achieve the aforementioned objective, the present invention provides a USB detection module for electrically coupling a USB female socket and switching a transmission mode of each transmission terminal of the USB female socket, and the detection module comprises a power control unit, an output unit, a detecting unit, a computing unit and an output control unit, wherein the power control unit is provided for receiving electric power, and the output unit is coupled to the power control unit and each transmission terminal of the USB female socket, and the detecting unit is coupled to the power control unit and the output unit for detecting each transmission terminal through the output unit and obtaining a detect signal, and the computing unit is coupled to the power control unit and the detecting unit, receiving the detect signal, and computing and comparing the detect signal to obtain a control signal, and then the output control unit receives the control signal and switch a transmission mode corresponsive to the control signal, and the power control unit controls the output unit according to the transmission mode for transmission.

When the USB female socket and the USB male socket with the same interface are electrically plugged with each other, the front or backside of the USB male socket can be connected to the female socket arbitrarily without any foolproof concern, so as to improve the convenience of use effectively.

### BRIEF DESCRIPTION OF THE DRAWINGS

FIG. 1 is an exploded view of a USB detection module and a USB female socket of the present invention; and

FIG. 2 is a schematic view of a USB detection module of the present invention.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

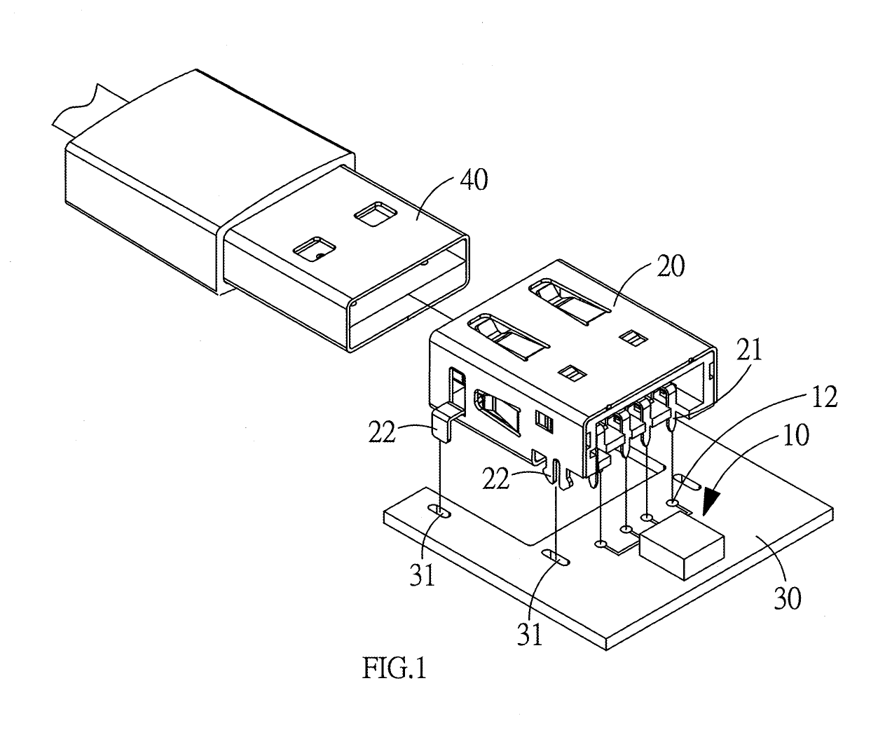

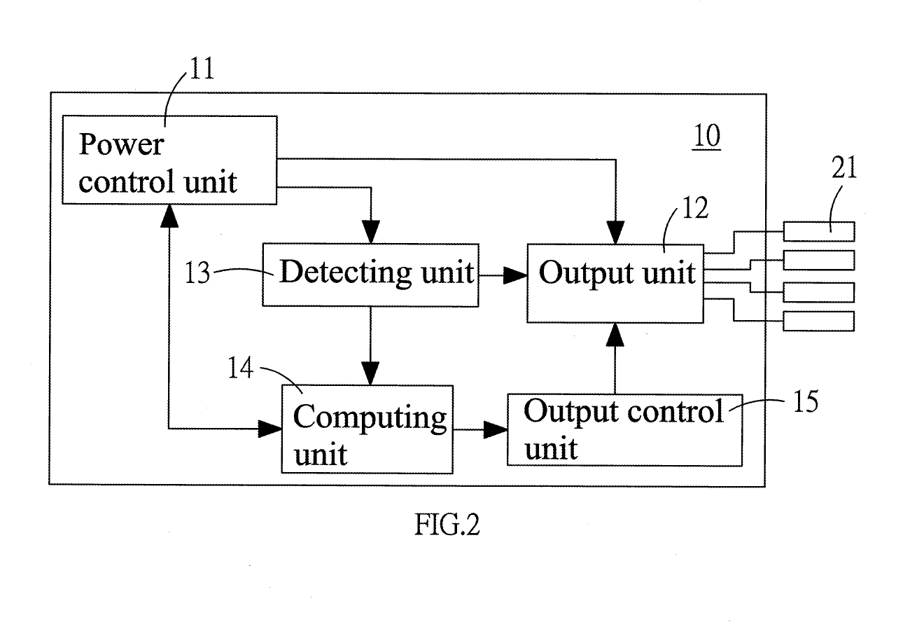

With reference to FIGS. 1 and 2 for an exploded view of a USB detection module and a USB female socket of the present invention and a schematic view of the USB detection module of the present invention respectively, the USB detection module 10 is provided for electrically coupling a USB female socket 20 and switching a transmission mode of each transmission terminal 21 of the USB female socket 20.

Wherein, the detection module 10 comprises a power control unit 11, an output unit 12, a detecting unit 13, a computing unit 14 and an output control unit 15. The power control unit 11 is provided for receiving electric power. The output unit 12 is coupled to the power control unit 11 and each transmission terminal 21 of the USB female socket.

The detecting unit 13 is coupled to the power control unit 11 and the output unit 12, and the electric power received by the power control unit 11 is converted into a detect current, and the detect current is used for detecting each transmission terminal 21 through the output unit 12 to obtain a detect signal.

The computing unit 14 is coupled to the power control unit 11 and the detecting unit 13 to receive the detect signal and perform a computation/comparison to obtain a control signal.

The output control unit 15 is coupled to the power control unit 11 and the output unit 12. The output control unit 15 receives the control signal, switches a transmission mode corresponsive to the control signal, and controls the output unit 12 for transmission according to the transmission mode.

In the embodiment as shown in the figures, the USB detection module 10 is electrically coupled to a printed circuit board 30, and the USB female socket 20 is electrically coupled to the printed circuit board 30, and the output unit 12 is disposed at an electric connection portion on the printed circuit board 30, and the electric connection portion is passed through a through hole of the printed circuit board and provided for passing and soldering each transmission terminal 21 of the USB female socket. The printed circuit board 30 further comprises at least one positioning hole 31, and the USB female socket 20 has a positioning portion 22 passing into the positioning hole 31.

Wherein, the printed circuit board 30 with the USB detection module 10 can be installed in an electronic device (such as a computer or a mobile phone), and the electronic device supplies the electric power. When the USB male socket 40 is plugged and electrically connected to the USB female socket 20, the detecting unit 13 uses a small current to detect each transmission terminal 21 through the output unit 12 and obtain a detect signal, and the computing unit 14 compute and compare the detect signal to obtain a control signal, and the output control unit 15 receives the control signal and switches a transmission mode corresponsive to the control signal, and the power control unit 11 controls the output unit 12 according to the transmission mode for transmission. For example, the output control unit 15 may switch to a transmission mode for a forward output, and allow the power control unit 11 to supply the electric power, so that the output unit 12 transmits electric power or signals through the transmission terminal 21.

Regardless of plugging the front or back side of the connecting USB male socket into the USB female socket, the transmission of the electric power or signals can be achieved without any foolproof concern, so as to improve the convenience of use effectively.

In summation of the description above, the present invention improves over the prior art, and is thus duly filed for patent application. While the invention has been described by means of specific embodiments, numerous modifications and variations could be made thereto by those skilled in the art without departing from the scope and spirit of the invention set forth in the claims.

What is claimed is:

1. A USB detection module, for electrically coupling a USB female socket and switching a transmission mode of each transmission terminal of the USB female socket, comprising;
a power control unit, for receiving electric power;
an output unit, coupled to the power control unit and each transmission terminal of the USB female socket;
a detecting unit, coupled to the power control unit and the output unit, for converting the electric power received by the power control unit into a detect current, and detecting each transmission terminal of the output unit by the detect current to obtain a detect signal;
a computing unit, coupled to the power control unit and the detecting unit, for receiving the detect signal, and performing a computation/comparison to obtain a control signal; and
an output control unit, coupled to the power control unit and the output unit, and
the output control unit receiving the control signal and switching to a transmission mode corresponding to the control signal, and the power control unit controlling a transmission of the output unit according to the transmission mode.

2. The USB detection module of claim 1, wherein the USB detection module is electrically coupled to a printed circuit board, and the USB female socket is electrically coupled to the printed circuit board.

3. The USB detection module of claim 2, wherein the output unit is disposed at an electric connection portion of the printed circuit board.

4. The USB detection module of claim 3, wherein the electric connection portion is passed through a through hole of the printed circuit board and provided for plugging and fixing each transmission terminal of the USB female socket.

5. The USB detection module of claim 2, wherein the printed circuit board further includes at least one positioning hole, and the USB female socket has a positioning portion passing through the positioning hole.
